(19) United States
(12) Patent Application Publication
(10) Pub. No.: US 2023/0422063 A1
(43) Pub. Date: Dec. 28, 2023

(54) Data Collection by Considering UE Interaction

(71) Applicant: Telefonaktiebolaget LM Ericsson (publ), Stockholm (SE)

(72) Inventors: Attila Báder, Paty (HU); Géza Szabó, Kecskemét (HU)

(21) Appl. No.: 18/037,900

(22) PCT Filed: Dec. 1, 2020
(86) PCT No.: PCT/IB2020/061322

§ 371 Date: May 19, 2023

(51) Int. Cl. H04W 24/08; H04W 24/10

(52) U.S. Cl. CPC H04W 24/08; H04W 24/10

(57) ABSTRACT

User-specific network analytics for application data services provided to user equipment (UEs) in a wireless network is disclosed herein. User interaction for an application data service and captured by an overlay on the UE triggers network analytics. The wireless network filters or otherwise controls the network analytics performed by the network node responsive to the trigger. In so doing, the user-specific network analytics disclosed herein decreases the network functions and analytics load at the network, and enables the network to focus on specific events, which enables the network to establish and support specific application goals.

### TECHNICAL FIELD

The solution presented herein relates generally to network analytics for application data services provided to user equipment (UEs) in a wireless network, and more particularly to user-specific network analytics for application data services provided to the UEs.

### BACKGROUND

Because sustained revenue growth, subscriber retention, etc. is significantly tied to subscriber experience, wireless service providers strive to deliver excellent subscriber experience. Part of that effort includes data analytics, which typically happens on a large scale. Such “big data analytics” are a useful tool for improving subscriber experience, but they provide little-to-no insight to specific aspects of the wireless service(s) that more negatively or positively impact subscriber experiences. Further, such big data analytics do not enable service providers to tailor generic big data solutions to their specific needs.

Expert Analytics provides one solution to this problem by providing a multi-vendor, cross-domain, big data analytics solution tailored to service providers. More particularly, Expert Analytics is designed to improve the subscriber experience and drive new revenue through a real-time, end-to-end telecommunication analytics solution offering unique insights and closed-loop actions. To that end, Expert Analytics measures the perceived experience of subscribers based on correlated metrics and events from network nodes, probes, devices, Operation Support System (OSS), Base Station System (BSS), and other sources. Expert Analytics also helps service providers predict, prioritize, and resolve subscriber-impacting events, as well as retain subscribers and upsell services based on experience and behavior profiles.

Expert Analytics supports a wide range of services, including challenging new services such as Voice over Long Term Evolution (VoLTE) and Voice over WiFi (VoWiFi), as well as encrypted Over-The-Top (OTT) traffic. Further, Expert Analytics is 5^{th} Generation (5G)-enabled for both core and radio, which provides essential insights that help telecommunication service providers successfully bring 5G capabilities to their subscribers. In addition, Expert Analytics addresses a broad range of telecommunication use cases and leverages the vast telecommunication domain knowledge and experience of network providers and provides a toolset to help service providers meet changing business and consumer demands. By converting data to insights, and converting insights to actions, e.g., via integration with various support systems, Expert Analytics delivers significant positive impacts in several key areas.

While Expert Analytics addresses some issues with previous big data analytics options, it is still data analytics on a large scale, and thus still requires large amounts of data. As newer radio technologies are introduced, along with the corresponding increased data rates, the amount of data available for data analytics will only increase. Ultimately, the increase in data will surpass the computational ability of the network analytics. Thus, there remains a need for improved network analytics techniques that accommodates and/or accounts for the large amounts of available data.

### SUMMARY

The solution presented herein addresses problems with big data analytics by providing user-specific network analytics for application data services provided to user equipment (UEs) in a wireless network. To that end, the solution presented herein triggers network analytics for an application data service responsive to user interaction with the corresponding application on the UE. By making the network analytics user-specific, the solution presented herein decreases the network functions and analytics load at the network, and enables the network to focus on specific events, which enables the network to establish and support specific application goals. Further, the reliance on the user interaction(s) to trigger network analytics renders the solution presented herein independent of any particular protocol and/or UE operating system (OS).

One exemplary embodiment comprises a method for user-specific network analytics for application data services provided to a UE by a wireless network. The method is performed by the UE and comprises establishing a user interaction overlay for the UE and capturing a user interaction with an application on the UE using the user interaction overlay. The application is configured to provide an application data service to the UE via the wireless network responsive to the captured user interaction. The method further comprises forwarding user activity data for the captured user interaction to a centralized application node in the wireless network to trigger user-specific network analytics for the application data service. The user activity data comprises a UE identifier, information regarding the captured user interaction, and at least one identifier for the corresponding application data service.

In exemplary embodiments, establishing the user interaction overlay comprises establishing a single user interaction overlay for the UE.

In exemplary embodiments, establishing the user interaction overlay comprises establishing a plurality of user interaction overlay segments for the UE, and capturing the user interaction comprises capturing, using one or more of the plurality of user interaction overlay segments, the user interaction with the application on the UE. In further exemplary embodiments, establishing the plurality of user interaction overlay segments comprises establishing the plurality of user interaction overlay segments according to a uniform grid. In further exemplary embodiments, the method further comprises determining a portion of a display of the UE involved in the user interaction responsive to a location of the one or more of the plurality of user interaction overlay segments used to capture the user interaction.

In exemplary embodiments, the method further comprises the user interaction overlay passing the captured user interaction to the application on the UE.

In exemplary embodiments, the method further comprises the user interaction overlay processing the captured user interaction for the application.

In exemplary embodiments, the method further comprises identifying the captured user interaction as either requiring a network response or as not requiring a network response, where forwarding the user activity data comprises only forwarding the user activity data to the centralized application node when the captured user interaction is identified as requiring a network response.

In exemplary embodiments, the user interaction comprises at least one of a voice command received by the UE, a user interaction with a screen of the UE, a user interaction with a control button of the UE, and a movement of the UE.

In exemplary embodiments, the information regarding the captured user interaction comprises a trigger indicating that one or more user interactions with the application occurred.

One exemplary embodiment comprises a UE in a wireless network. The UE is configured to receive wireless application data services via the wireless network. The UE comprises one or more processing circuits configured to execute the UE method disclosed herein.

One exemplary embodiment comprises a method for user-specific network analytics for application data services provided to UE by a wireless network. The method is performed by a centralized application node in the wireless network and comprises receiving user activity data from a plurality of UEs regarding user interactions with an application on each of the plurality of UEs. The application is configured to provide an application data service to the corresponding UE via the wireless network responsive to the user interactions. The method further comprises controlling a configuration of at least one filter in a network management node communicatively coupled to the centralized application node to limit network analytics performed by the network management node responsive to the received user activity data.

In exemplary embodiments, controlling the configuration of the at least one filter in the network management node comprises controlling the configuration of the at least one filter to limit events data provided by one or more network functions to the network management node responsive to the received user activity data.

In exemplary embodiments, controlling the configuration of the at least one filter in the network management node comprises controlling the configuration of the at least one filter to limit events data used for the network analytics by the network management node responsive to the received user activity data.

In exemplary embodiments, the method further comprises generating a white list of UEs responsive to the received user activity data, where controlling the configuration of the at least one filter comprises sending the white list to the at least one filter to limit the network analytics performed by the network management node to network analytics for the UEs listed in the white list.

In exemplary embodiments, controlling the configuration of the at least one filter comprises sending UE identifiers for the plurality of UEs to the at least one filter to limit the network analytics performed by the network management node to network analytics for one or more of the UEs having a UE identifier that maps to an identifier for at least one network node selected for analysis.

In exemplary embodiments, the method further comprises correlating the received user activity data with application data regarding a performance of the application on the plurality of UEs to generate a filter configuration for the at least one filter in the network management node. In exemplary embodiments, the application data comprises data corresponding to user plane traffic provided to the centralized network node.

In exemplary embodiments, controlling the configuration of the at least one filter comprises periodically controlling the configuration of the at least one filter. In exemplary embodiments, controlling the configuration of the at least one filter periodically comprises controlling the configuration of the at least one filter once a day.

In exemplary embodiments, controlling the configuration of the at least one filter comprises controlling the configuration of the at least one filter upon receipt of the user activity data. In exemplary embodiments, controlling the configuration of the at least one filter upon receipt of the user activity data comprises controlling the configuration of the at least one filter to limit network analytics performed by the network management node while the wireless network provides the corresponding application data service to the corresponding UE.

One exemplary embodiment comprises a centralized application node in a wireless network configured to provide wireless application data services to one or more UE in the wireless network. The centralized application node comprising one or more processing circuits configured to execute the centralized application node method disclosed herein.

One exemplary embodiment comprises a centralized application node configured to facilitate user-specific network analytics for application data services provided to UE by a wireless network. The centralized application node comprises an overlay application server and an application circuit. The overlay application server is configured to receive user activity data from a plurality of UEs regarding user interactions with an application on each of the plurality of UEs. The application is configured to provide an application data service to the corresponding UE via the wireless network responsive to the user interactions. The application circuit is configured to control a configuration of at least one filter in a network management node communicatively coupled to the centralized application node to limit network analytics performed by the network management node responsive to the received user activity data.

One exemplary embodiment comprises a method for user-specific network analytics for application data services provided to UE by a wireless network. The method is performed by a network management node in the wireless network and comprises configuring at least one filter in the network management node responsive to a filter configuration provided by a centralized application node communicatively coupled to the network management node. The filter configuration is representative of user activity data indicative of user interaction with an application on a corresponding UE. The application is configured to provide an application data service to the corresponding UE via the wireless network responsive to the user interaction. The method further comprises limiting network analytics performed by a network analytics circuit in the network management node responsive to the at least one configured filter.

In exemplary embodiments, configuring the at least one filter in the network management node comprises configuring the at least one filter to limit events data provided by one or more network functions to the network analytics circuit responsive to the received filter configuration.

In exemplary embodiments, the method further comprises receiving events data from one or more network functions communicatively coupled to the network management node, where configuring the at least one filter in the network management node comprises configuring the at least one filter to limit events data used by the network analytics circuit for network analytics to a subset of the received events data responsive to the filter configuration.

In exemplary embodiments, the method further comprises receiving a white list of UEs from the centralized network node. The white list is generated by the centralized application node responsive to the user activity data, wherein configuring the at least one filter comprises configuring the at least one filter responsive to the received white list. In exemplary embodiments, configuring the at least one filter in the network management node comprises receiving user identifiers associated with the user activity data from the centralized network node, and configuring the at least one filter in the network management node to limit events data provided to the network analytics circuit for analysis to events data associated with one or more user identifiers that map to an identifier for at least one network node selected for analysis.

In exemplary embodiments, configuring the at least one filter comprises configuring the at least one filter periodically. In exemplary embodiments, configuring the at least one filter periodically comprises configuring the at least one filter once a day.

In exemplary embodiments, configuring the at least one filter comprises configuring the at least one filter upon receipt of the filter configuration. In exemplary embodiments, the method further comprises performing the network analytics while the wireless network provides the corresponding application data service to the corresponding UE.

One exemplary embodiment comprises a network management node in a wireless network configured to provide wireless application data services to one or more UE in the wireless network. The network management node comprises one or more processing circuits configured to execute the network management node method disclosed herein.

One exemplary embodiment comprises a network management node configured to implement user-specific network analytics for application data services provided to UE by a wireless network. The network management node comprises a filter circuit and a network analytics circuit. The filter circuit is configured responsive to a filter configuration provided by a centralized application node communicatively coupled to the network management node. The filter configuration is representative of user activity data indicative of user interaction with an application on a corresponding UE. The application is configured to provide an application data service to the corresponding UE via the wireless network responsive to the user interaction. The network analytics circuit is configured to limit network analytics performed by the network management node responsive to the at least one configured filter circuit.

### BRIEF DESCRIPTION OF THE DRAWINGS

FIG. 1 shows a wireless network according to exemplary embodiments of the solution presented herein.

FIG. 2 shows a method performed by the UE in the wireless network according to exemplary embodiments of the solution presented herein.

FIG. 3 shows a method performed by the centralized app node in the wireless network according to exemplary embodiments of the solution presented herein.

FIG. 4 shows a method performed by the network management node in the wireless network according to exemplary embodiments of the solution presented herein.

FIG. 5 shows overlay creation according to exemplary embodiments of the solution presented herein.

FIG. 6 shows user interaction with the overlay according to exemplary embodiments of the solution presented herein.

FIG. 7 shows overlay creation according to other exemplary embodiments of the solution presented herein.

FIG. 8 shows user interaction with the overlay according to exemplary embodiments of the solution presented herein.

FIG. 9 shows a non-real-time method according to exemplary embodiments of the solution presented herein.

FIG. 10 shows a real-time method according to exemplary embodiments of the solution presented herein.

FIG. 11 shows a block diagram for an exemplary UE according to exemplary embodiments of the solution presented herein.

FIG. 12 shows a block diagram for an exemplary network management node according to exemplary embodiments of the solution presented herein.

FIG. 13 shows a block diagram for a centralized app node according to exemplary embodiments of the solution presented herein.

### DETAILED DESCRIPTION

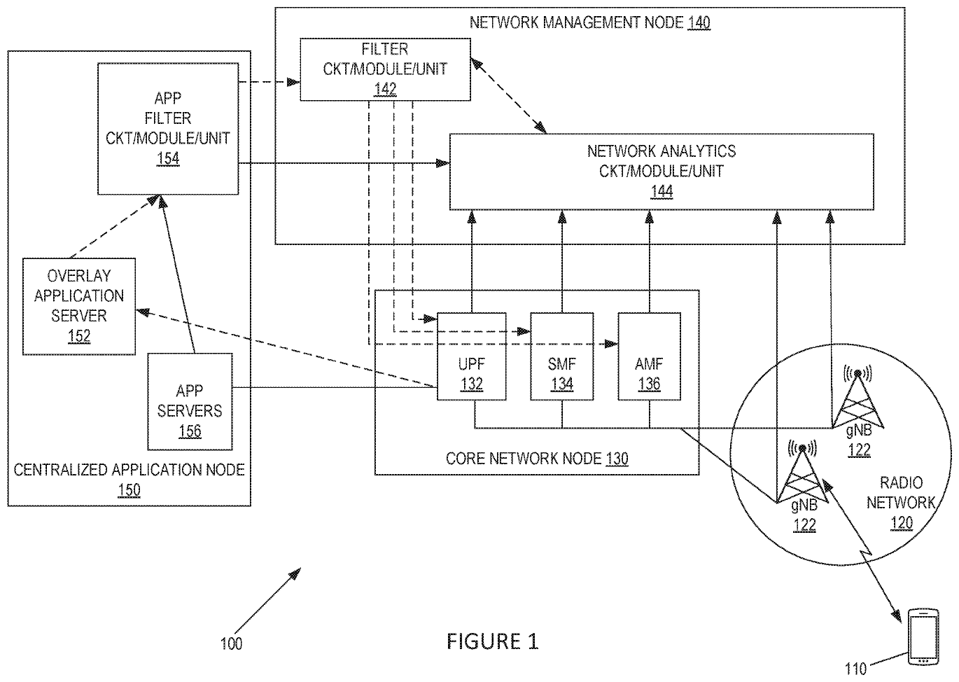

FIG. 1 shows an exemplary wireless network 100 configured to implement user-specific network analytics according to embodiments of the solution presented herein. Wireless network 100 comprises a User Equipment (UE) 110, radio network 120, core network node 130, network management node 140, and centralized application node 150. UE 110 communicates via uplink and downlink wireless communications with access points 122, e.g., gNB 122, in radio network 120, which in turn communicate with the core network node 130 according to any know wireless standard. Conventional wireless communications between the UE 110, radio network 120, and core network node 130 enable the user of the UE 110 to communicate with other users, implement applications on the UE 110, etc. Such conventional wireless communications between the UE 110, radio network 120, and core network node 130 are well understood in the art and are not discussed further herein. It will be appreciated that FIG. 1 shows one UE 110 and one radio network 120 for simplicity; the solution presented herein is applicable for wireless networks 100 comprising multiple radio networks 120 and/or multiple UEs 110.

Core network node 130 is also communicatively coupled to network management node 140 and centralized application node 150 to provide the data necessary to implement the user-specific network analytics according to the solution presented herein. Generally, and as discussed in further detail herein, user interaction with an application 115 on the UE 110 is captured by an overlay 114 on the UE 110 and conveyed to centralized application node 150 as part of user activity data via the core network node 130. The conveyed user activity data triggers the centralized application node 150 to control a filter (142) (or filters 142) in the network management node 140 to control the information provided to and/or used by the network management node 140 such that only network analytics for specific applications, users, nodes, etc., are executed. In so doing, the solution presented herein decreases the network functions and analytics load at the network, as well as enables the network to focus on specific events, enabling the network to establish and support specific application goals. Further, the reliance on the user interaction(s) to trigger the network analytics renders the solution presented herein independent of any particular protocol and/or UE operating system (OS).

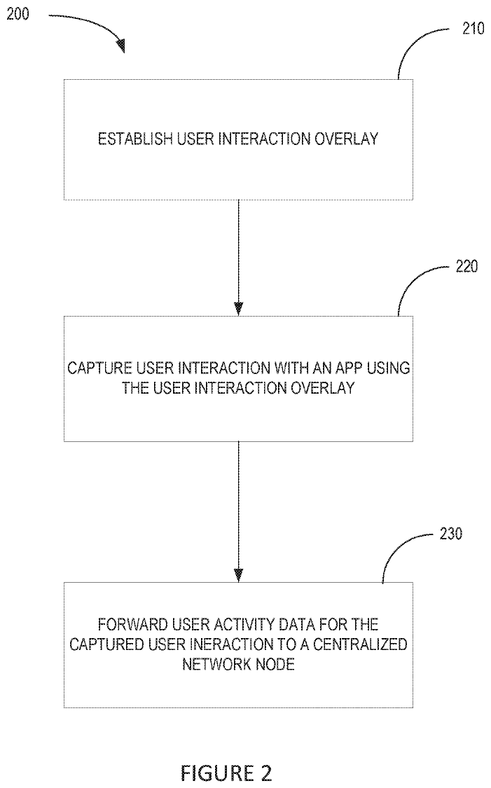

The following first generally describes the solution presented herein using FIGS. 2-4 from the perspective of the UE 110, centralized application node 150, and network management node 140, respectively. Subsequently, additional details will be provided for each of the UE 110, centralized application node 150, and network management node 140 regarding the solution presented herein. For simplicity, and without loss of generality, applications 115, 117 will be generally referred to as “app 115” or “overlay app 117,” as appropriate.

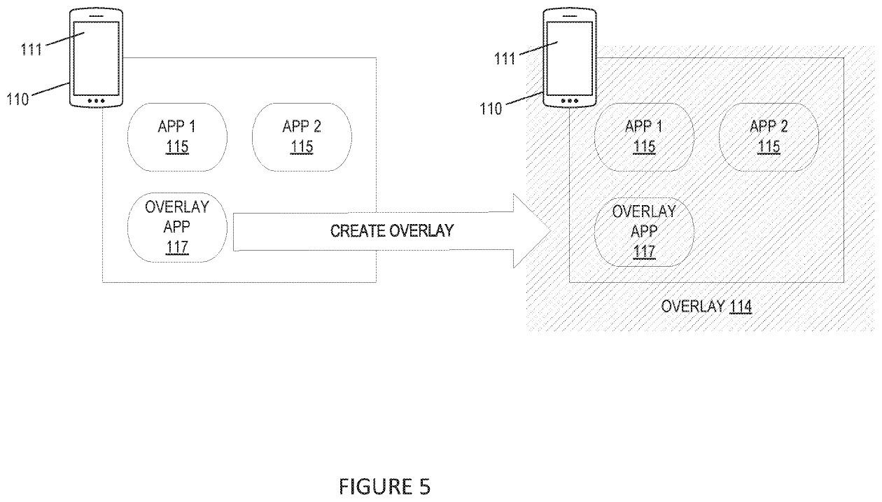

FIG. 2 shows a method 200 for user-specific network analytics for application data services provided to a UE 110 by a wireless network 100 according to solutions presented herein, where the method 200 is performed by the UE 110. Method 200 comprises establishing a user interaction overlay 114 for the UE 110 (block 210). The method further comprises capturing a user interaction with an app 115 on the UE 110 (see FIG. 5, for example) using the user interaction overlay 114 (block 220), where the app 115 is configured to provide an application data service to the UE 110 via the wireless network 100 responsive to the captured user interaction. Method 200 further comprises forwarding user activity data for the captured user interaction to the centralized application node 150 to trigger user-specific network analytics for the application data service (block 230). In exemplary embodiments, the user activity data comprises a UE identifier, information regarding the captured user interaction, and at least one identifier for the corresponding application data service.

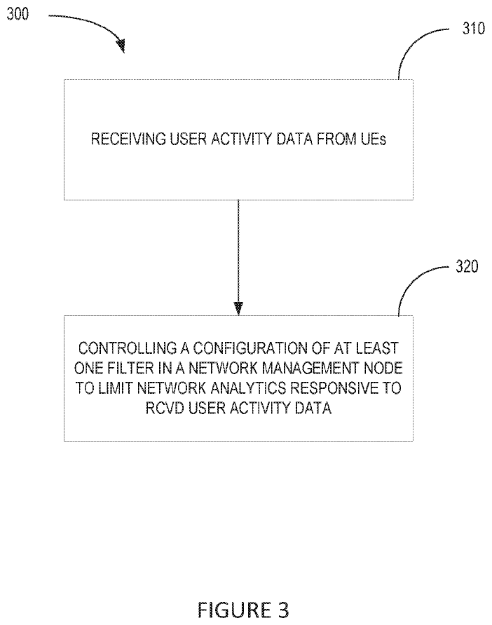

FIG. 3 shows a method 300 for user-specific network analytics for application data services provided to UE 110 by a wireless network 100, where the method 300 is performed by the centralized application node 150. Method 300 comprises receiving user activity data from a plurality of UEs 110 regarding user interactions with an app 115 on each of the plurality of UEs 110, where the app 115 provides an application data service to the corresponding UE 110 via the wireless network 100 responsive to the user interactions (block 310). The method 300 further comprises controlling a configuration of at least one filter 142 in the network management node 140 to limit network analytics performed by the network management node 140 responsive to the received user activity data (block 320).

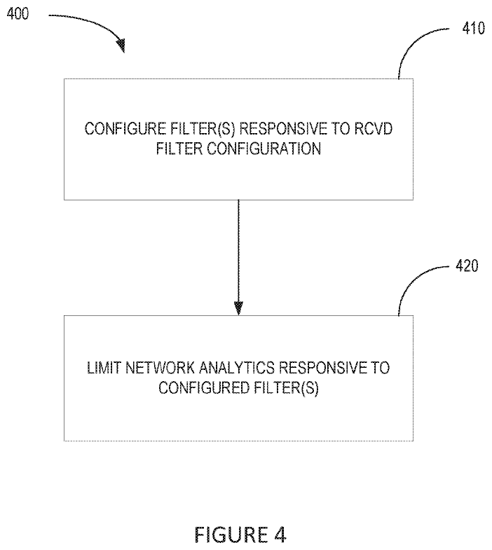

FIG. 4 shows a method 400 for user-specific network analytics for application data services provided to the UE 110 by the wireless network 100, where the method 400 is performed by the network management node 140. The method 400 comprises configuring the filter(s) 142 responsive to a filter configuration provided by the centralized application node 150 (block 410). The filter configuration is representative of user activity data indicative of user interaction with an app 115 on a corresponding UE 110, where the app 115 provides an application data service to the corresponding UE 110 via the wireless network 100 responsive to the user interaction. The method 400 further comprises limiting the network analytics performed by a network analytics circuit 144 in the network management node 140 responsive to the configured filter(s) 142 (block 420).

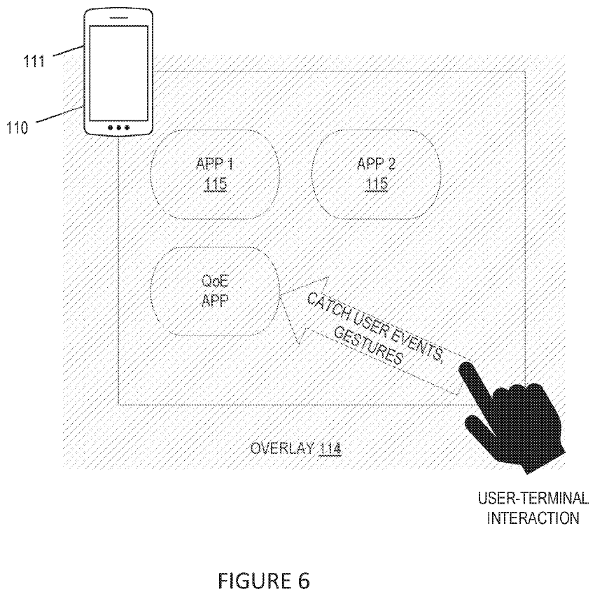

As can be seen from FIGS. 2-4, the UE 110, centralized application node 150 and network management node 140 work together responsive to user interactions captured by an overlay 114 on the UE 110 to control and/or otherwise limit the network analytics performed by the network management node 140. To that end, UE 110 includes an overlay app 117 configured to create the overlay 114 that captures user interactions with one or more apps 115 according to solutions presented herein, as shown in FIG. 5. Exemplary overlay apps 117 include, but are not limited to, a Quality of Experience (QoE) app 117. The overlay 114 created by overlay app 117 is transparent both visually and functionally, and thus neither interferes with the user's sight and/or gestures nor the user's interaction with the various apps 115. Overlay 114 is configured to capture all user interactions with the UE 110. Such interactions include, but are not limited to touch interactions (e.g., display tap, display swipe, control button activation, etc.), movement of the UE 110 (e.g., shaking, lifting up, etc.), voice commands, etc. For example, the overlay 114 may detect the user's hand/finger touching the display 111 (e.g., tapping or swiping motion) as shown in FIG. 6.

Overlay 114 forwards the captured user interaction to overlay app 117. In response to the captured user interaction, the overlay app 177, generates user activity data to send to the centralized application node 150. The user activity data at least includes general information related to the user interaction, e.g., the UE identifier, information regarding the captured user interaction, and at least one identifier for the application data service associated with the app 115 with which the user interacted. Additional information, while not required, may also be included, e.g., time of user interaction, type of user interaction, frequency of user interaction with the corresponding app 115, response required of the UE 110 in light of the user interaction, etc. In some exemplary embodiments, the information regarding the captured user interaction may comprise an indication, e.g., a trigger in the form of a toggled bit, that the user interaction occurred. In other exemplary embodiments, the information regarding the captured user interaction be implied simply by the transmission of the user activity data. For example, the central application node 150 may interpret received user activity data having only the UE and app identifiers as an implied indication that the overlay 114 of the corresponding UE 110 detected a user interaction with the corresponding app 115.

In some exemplary embodiments, overlay 114 forwards the detected user interaction to overlay app 117, while the corresponding app 115 separately detects the user interaction and responds accordingly. In this case, the apps 115 and overlay app 117 operate independently. In other embodiments, e.g., when supported by the UE's operating system, apps 115 and overlay app 117 may operate cooperatively. For example, the overlay app 117 may forward the detected user interaction to the corresponding app 115, or may process the detected user interaction on behalf of the app 115, e.g., to provide the associated instruction to the app 115.

In some embodiments, the overlay app 117 generates and forwards user activity data for each captured user interaction. In other embodiments, the overlay app 117 may also further control which user interactions trigger the transmission of user activity data to the centralized application node 150. For example, if the user interaction with the app 115 does not require a response from the network 100, e.g., the requested multi-media data (e.g., picture, video, etc.) is already stored on the UE 110, the overlay app 117 may disregard the detected user interaction. If, however, the user interaction with the app 115 requires a network response, e.g., requires the network 100 to download the requested multi-media data, the overlay app 117 generates and forwards the user activity data. In either case, the overlay app 117 may forward the user activity data each time a user interaction is captured, may periodically forward the user activity data according to a predetermined schedule (e.g., every minute, every hour, etc.), or may forward the user activity data according to a data volume threshold (e.g., each time there are some number of accumulated user activity data records).

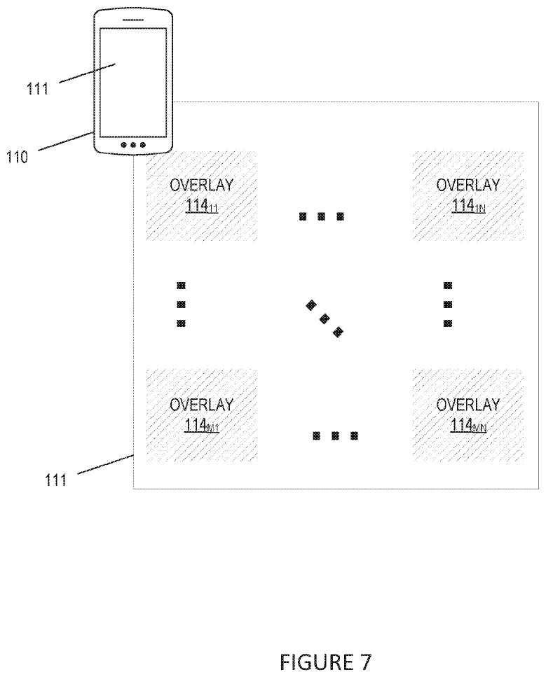

FIGS. 5 and 6 show a single overlay 114 encompassing all of UE 110. In some exemplary embodiments, however, the overlay 114 may comprise a plurality of overlay segments 114. For example, FIG. 7 shows an exemplary overlay 114 comprising a grid of overlay segments 114₁₁-114_{MN} arranged uniformly on a display 111 of the UE 110. While FIG. 7 shows equal sized overlay segments 114₁₁-114_{MN}, it will be appreciated that the overlay segments 114₁₁-114_{MN} may not all be the same size. Further, it will be appreciated that the overlay segments 114₁₁-114_{MN} are not required to be arranged according to a uniform grid, and in some cases may be clustered more closely together in parts of the display 111 that typically receive more user interaction, e.g., the middle and/or bottom of the display 111. When the display 111 includes the overlay segments 114₁₁-114_{MN} of FIG. 7, it will be appreciated that other overlay segments 114 may be included for various control buttons, motion sensors, microphones, etc., to capture user interaction with non-display portions of the UE 110. In any event, while the overlay segments 114₁₁-114_{MN} may represent a more complex overlay 114, they also provide some advantages not readily available with the single overlay 114. For example, because the overlay app 117 knows the location of each overlay segment 114₁₁-114_{MN}, the overlay app 117 may determine the location of the user interaction, e.g., middle of the display 111, edge of the display 111, etc., based on which overlay segments 114₁₁-114_{MN} detected the user interaction.

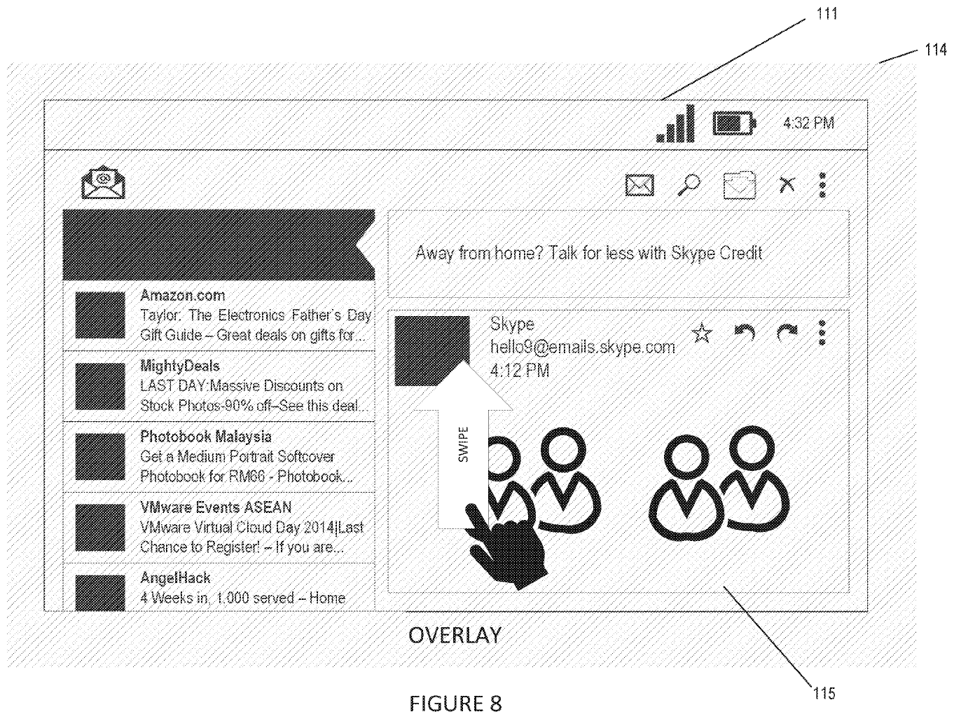

In some exemplary embodiments, the user interaction may be correlated with the user interface, e.g., Graphical User Interface (GUI), that the user is interacting with. Such correlations may be included with the user activity data, and/or may be used to determine whether the user interaction requires a network response. For example, the overlay app 117 may capture one or more screenshots of the foreground process and create rules that refer to the interactions for specific apps for specific layouts. FIG. 8 shows one example for correlating a swiping user interaction with the user interface.

Referring back to FIG. 1, FIG. 3, and FIG. 4, we now discuss the operation of the centralized application node 150 and the network management node 140 according to the solution presented herein. The centralized application node 150 comprises an overlay application server 152, a plurality of app servers 156, and an app filter circuit 154. The network management node 140 comprises one or more filters 142 and a network analytics circuit 144. The filter(s) 142 control the network analytics performed by the network analytics circuit 144 responsive to the filter configuration provided by the app filter circuit 154. In so doing, the app filter circuit 154 limits the network analytics to network analytics associated with specific users, apps 115, nodes 122, and/or application data services that are responding to one or more user interactions with one or more UEs 110.

More particularly, upon receipt of user activity data from a UE 110, the core network node 130 provides the user activity data to an overlay application server 152 in the centralized network node 150. The app filter circuit 154 correlates the user activity data provided by the overlay application server 152 with the app data provided by the app servers 156 to determine the filter configuration. The filter(s) 142 receive the filter configuration and control the data received and/or used by the network analytics system 144 responsive to the received filter configuration.

As discussed in further detail below, the app filter circuit 154 may provide the filter configuration to the filter(s) 142 each time new user activity data is received, e.g., to implement more real time network analytics. Alternatively, the app filter circuit 154 may provide the filter configuration to the filter(s) 142 periodically, e.g., daily, or on command. In this case, the corresponding user-specific network analytics would be non-real time analytics.

In some exemplary embodiments, the app filter circuit 154 generates a white list of subscribers responsive to the correlation of the user activity data provided by overlay application server 152 with the app data provided by the app servers 156. Alternatively, the filter circuit(s) 142 may generate the white list responsive to the correlation provided by the app filter circuit 154. By providing this white list of subscribers to the filter(s) 142, or by providing the correlations to the filter(s) 142 to enable the filter(s) 142 to generate the white list, the centralized application node 150 configures the filter(s) 142 to limit network analytics to network analytics for only those subscribers in the white list. More particularly, the filter(s) 142 limit the network analytics performed by the network analytics circuit 144 to those network analytics associated with subscriber services for only the subscribers in the white list. In some instances, the number of subscribers in the white list may be too high, e.g., may exceed some predetermined threshold. I such cases, the app filter circuit 154 may use sampling to reduce the number of subscribers in the white list, e.g., random sampling. Alternatively or additionally, the app filter circuit 154 may use other means to reduce the number of subscribers in the white list, e.g., limit the white list to the subscribers having more user interactions with a corresponding app, limit the white list to the subscribers having higher amounts of data transferred during a corresponding application data session, etc. In any event, such reductions ultimately eliminate some subscribers from the network analytics. However, the fact that such reductions occur in response to the number of subscribers in the white list being too high still ensures there will be sufficient data to derive the general quality of a corresponding application data service and/or to identify network issues causing any service quality degradations.

Alternatively or additionally, the filter configuration generated by the app filter 154 may limit the events data associated with one or more network functions, e.g., User Plane Function (UPF) 132, Session Management Function (SMF) 134, and Access and mobility Management Function (AMF) 136, that are used by the network management node 140 for analysis. For example, the filter configuration provided by the app filter circuit 154 may configure the filter(s) 142 to limit the events data actually provided by the network functions 132, 134, 136 to the network management node 140 or may configure the filter(s) 142 to limit the events data actually used by the network management 140 for analysis.

Alternatively, or additionally, the filter configuration generated by the app filter 154 may comprise one or more of the user identifiers from the received user activity data that map to an identifier for one or more particular network nodes 122. In this case, the filter configuration limits the network analytics by configuring the filter(s) 142 to limit the events data provided to the network analytics circuit 144 to the events data for the user identifier(s) associated with the particular network node(s) 122. For example, the configured filter(s) 142 may limit the events data actually provided by the network functions 132, 134, 136 to the network analytics circuit 144 to only the events data for particular subscribers from particular node(s) 122. In another example, the configured filter(s) 142 may limit the events data from the network functions 132, 134, 136 actually used by the network analytics circuit 144 to only the events data for particular subscribers from particular node(s) 122. In some instances, the amount of events data associated with the particular subscribers from particular node(s) 122 may be too high, e.g., may exceed some predetermined threshold, in which case the configured filter(s) 142 may use sampling to reduce the amount of events data, e.g., random sampling. Alternatively or additionally, the configured filter(s) 142 may use other means to reduce the amount of events data, e.g., limit the events data to the events data associated with subscribers having more user interactions with a corresponding app, limit the events data to the events data associated with application data sessions having higher amounts of data transferred. In any event, such reductions ultimately eliminate some events data from the network analytics. However, the fact that such reductions occur in response to there being too much events data still ensures there will be sufficient events data to derive the general quality of a corresponding application data service and/or to identify network issues causing any service quality degradations.

It will be appreciated that the solution presented herein may be executed in non-real-time or in real-time. For non-real-time operation, the centralized application server 150 regularly, but not immediately, sends the filter configuration information to the network management node 140, and the filter circuit(s) 142 regularly, but not immediately, update and/or implement the filter configuration. Non-real-time operation may be necessary or desirable for various reasons. For example, in some instances the available technology may not be fast enough to complete the filtering loop to implement the user-specific network analytics during a particular session. Alternatively, or additionally, limitations to available filtering options may further slow down the process, rendering real-time operation implausible.

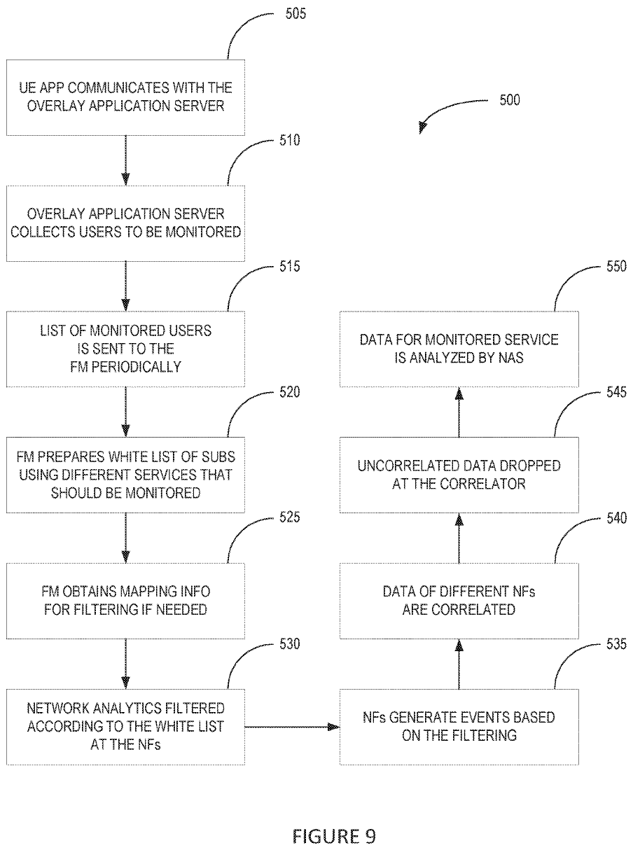

FIG. 9 shows one non-real-time method 500 according to one exemplary embodiment. In non-real-time operation, the UEs 110 communicate user activity data to the centralized app node 150 via the core network node 130 (block 505). The overlay app server 152 collects the user activity data from multiple UEs 110 to identify the services/subscribers that should be monitored (block 510). This list (containing the subs or UE IDs and the Application ID) is sent not sent immediately, but instead is sent periodically (e.g., every hour or once a day) to the filter circuit(s) 142 (block 515). The filter circuit(s) 142 prepare a white list of the subscribers using different services that should be monitored (block 520). Note that if the number of subscribers using a service is too high, random sampling may be applied to the subscribers using the same service. The filter circuit(s) 142 then obtain any mapping information needed to implement the filtering (block 525). Because the filter circuit(s) 142 know the filtering capabilities of the network functions 132, 134, 136, the filter circuit(s) 142 are aware when certain network functions 132, 134, 136 do or do not support various filter operations, and can thus adjust the filtering accordingly. For example, if a network function 132, 134, 136 does not support International Mobile Subscriber Identity (IMSI) or SUbscription Permanent Identifier (SUPI) filtering or if the network function 132, 134, 136 uses another identifier for data flow or session identification (e.g., user IP address), the filter circuit(s) 142 use mapping info from the network analytics circuit 144 to translate or otherwise map the received filter configuration information to the identifiers (e.g., slice or IP address) or filtering that is supported by the network function 132, 134, 136. In another example, a network function 132, 134, 136 may not support any per-session filtering. In this case, the IMSI/SUPI is mapped to a larger network identifier, e.g., Slice, Access Point Name (APN), Data Network Name (DNN), etc. for which filtering is supported. It will be appreciated that reduction sampling, e.g., random sampling, may be applied for these larger network IDs. In yet another example, a network function 132, 134, 136 may not support the appropriate filtering. In this case, the network functions 132, 134, 136 that does not support the appropriate filtering may report events for all subscribers, where correlator logic of the network analytics circuit 144 drops the uncorrelated events responsive to the configuration of the filter circuit(s) 142 such that user records are created only for the required sessions (subscribers). In any event, the network analytics performed by the network analytics circuit 144 are filtered, e.g., according to the IMSI/SUPI white list, the mapped Session ID white list, the Application IDs, and/or or the mapped network IDs (block 530). When the filtering is applied to one or more of the network functions 132, 134, 136, the network function(s) 132, 134, 136 generate events data responsive to the filtering (block 535) and send the generated events data to the network analytics circuit 144. The network analytics circuit 144 correlates events data from different network functions 132, 134, 136 (block 540), drops the uncorrelated data at the correlator (545), and analyzes the data for the monitored service to provide non-real-time network analytics (block 550).

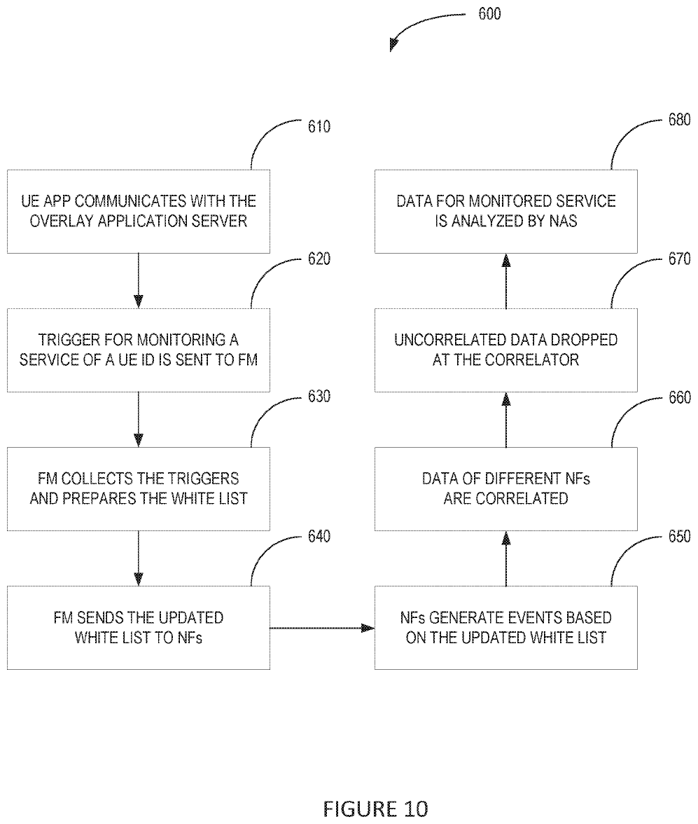

For real-time operation, the solution presented herein updates the filter configuration upon receipt of new user activity data. To that end, the filtering loop for the solution presented herein needs to be fast enough to activate the collection of the appropriate events data for the same session that was triggered by the user interaction. FIG. 10 shows a real-time method 600 according to one exemplary embodiment of the solution presented herein. In this example it is assumed the network functions 132, 134, 136 are able to receive and add IMSI/SUPIs to the white list on demand very frequently. The UEs 110 communicate the user activity data to the centralized app node 150 via the core network node 130 (block 610). The overlay app server 152 collects the user activity data one or more UEs 110 and sends the corresponding trigger(s) to the filter circuit(s) 142 (block 620). The filter circuit(s) 142 collect the triggers and prepare the corresponding white list (block 630) and sends the updated white list to the network functions 132, 134, 136 (block 640). In some cases, the filter circuit(s) 142 may send the entire updated white list each time the white list changes. In other cases, the filter circuit(s) 142 may only send the new white list information, e.g., to add or remove subscribers from the white list. For example, if a service usage should be monitored, the overlay app 117 in the corresponding UE 110 sends a trigger of the user interaction immediately to the overlay app circuit 152, which forwards this trigger to the filter circuit(s) 142 via the app filter circuit 154. The filter circuit(s) 142 collects all these requests in a short time scale (e.g., on the order of a few seconds), and sends the list of IMSI/SUPIs to the network functions 132, 134, 136 immediately, which immediately add these to the monitored white lists. In any event, when the filtering is applied to one or more of the network functions 132, 134, 136, the network function(s) 132, 134, 136 generate events data responsive to the filtering (block 650) and send the generated events data to the network analytics circuit 144. The network analytics circuit 144 correlates events data from different network functions 132, 134, 136 (block 660), drops the uncorrelated data at the correlator (670), and analyzes the data for the monitored service to provide non-real-time network analytics (block 680).

Real-time implementations of the solution presented herein are similar to the non-real-time implementations, but are different in a few key ways. For example, during real-time operation the identifier information is sent immediately to the filter circuit(s) 142, e.g., by continuously sending small update messages, while during non-real-time operation, the identifier information is sent periodically and infrequently to the filter circuit(s) 142, e.g., once per hour or once per day. Further, the filtering is updated immediately during real-time operation, e.g., with a new UE identifier. As such, real-time implementations of the solution presented herein are more suitable for subscriber care and real-time troubleshooting for a particular session. Real-time operation, however, is not always feasible for a variety of reasons, as discussed above. Thus, non-real-time operation also provides a useful tool for improving network analytics by still enabling user-specific network analytics.

In both real-time and non-real-time operation, it will be appreciated that the network analytics for a particular data session eventually terminate. Such termination may be responsive to expiration of a timer and/or responsive to the termination of the corresponding session.

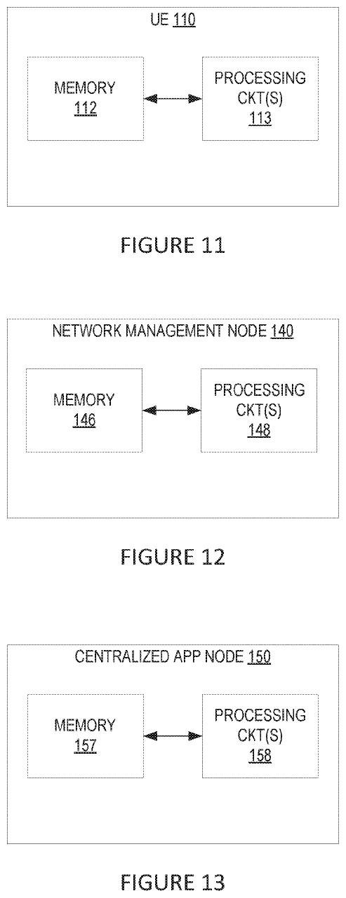

FIG. 11 shows a block diagram for an exemplary UE 110. UE 110 comprises memory 112 and one or more processing circuits 113. The processing circuits 113 are configured to execute method 200 according to embodiments of the solution presented herein.

FIG. 12 shows a block diagram for an exemplary network management node 140. Network management node 140 comprises memory 146 and one or more processing circuits 148. The processing circuits 148 are configured to execute method 300 according to embodiments of the solution presented herein.

FIG. 13 shows a block diagram for a centralized app node 150. Centralized app node 150 comprises memory 157 and one or more processing circuits 158. The processing circuits 158 are configured to execute method 400 according to embodiments of the solution presented herein.

As used herein, the term “user equipment” or “UE” may include any mobile terminal, including but not limited to, a cellular radiotelephone with or without a multi-line display; a Personal Communication System (PCS) terminal that may combine a cellular radiotelephone with data processing, facsimile, and data communications capabilities; a Personal Digital Assistant (PDA) that can include a radiotelephone, pager, Internet/intranet access, web browser, organizer, calendar, and/or a global positioning system (GPS) receiver; and a conventional laptop and/or palmtop receiver or other appliance that includes a radiotelephone transceiver. Mobile terminals may also be referred to as “pervasive computing” devices.

Note that the apparatuses described herein may perform the methods described herein, and any other processing, by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For example, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein. Thus, various apparatus elements disclosed herein, e.g., an overlay application server 152, app servers 156, app filter circuit 154, filter circuit 142, network analytics circuit 144, etc., may implement any functional means, modules, units, or circuitry, and may be embodied in hardware and/or in software (including firmware, resident software, microcode, etc.) executed on a controller or processor, including an application specific integrated circuit (ASIC).

The solution presented herein may, of course, be carried out in other ways than those specifically set forth herein without departing from essential characteristics of the solution. The present embodiments are to be considered in all respects as illustrative and not restrictive, and all changes coming within the meaning and equivalency range of the appended claims are intended to be embraced therein.

1-35. (canceled)

36. A method to enable user-specific network analytics for application data services provided to a user equipment (UE) by a wireless network, the method performed by the UE and comprising:
establishing a user interaction overlay for the UE;
capturing a user interaction with an application on the UE using the user interaction overlay, said application configured to provide an application data service to the UE via the wireless network responsive to the captured user interaction; and
forwarding user activity data for the captured user interaction to a centralized application node in the wireless network to trigger user-specific network analytics for the application data service, said user activity data comprising a UE identifier, information regarding the captured user interaction, and at least one identifier for the corresponding application data service.

37. The method of claim 36, wherein establishing the user interaction overlay comprises establishing a single user interaction overlay for the UE.

38. The method of claim 36, wherein:
establishing the user interaction overlay comprises establishing a plurality of user interaction overlay segments for the UE; and
capturing the user interaction comprises capturing, using one or more of the plurality of user interaction overlay segments, the user interaction with the application on the UE.

39. The method of claim 38, wherein establishing the plurality of user interaction overlay segments comprises establishing the plurality of user interaction overlay segments according to a uniform grid.

40. The method of claim 38, further comprising determining a portion of a display of the UE involved in the user interaction responsive to a location of the one or more of the plurality of user interaction overlay segments used to capture the user interaction.

41. The method of claim 36, wherein the user interaction overlay passes the captured user interaction to the application on the UE.

42. The method of claim 36, wherein the user interaction overlay processes the captured user interaction for the application.

43. The method of claim 36, further comprising:
identifying the captured user interaction as either requiring a network response or as not requiring a network response;
wherein forwarding the user activity data comprises only forwarding the user activity data to the centralized application node when the captured user interaction is identified as requiring a network response.

44. The method of claim 36, wherein the user interaction comprises:
a voice command received by the UE; and/or
a user interaction with a display of the UE; and/or
a user interaction with a control button of the UE; and/or
a movement of the UE.

45. The method of claim 36, wherein the information regarding the captured user interaction comprises a trigger indicating that one or more user interactions with the application occurred.

46. A user equipment (UE) for enabling user-specific network analytics for application data services provided to the UE by a wireless network, the UE comprising:
processing circuitry and memory circuitry, the memory circuitry storing instructions executable by the processing circuitry whereby the UE is configured to:
establish a user interaction overlay for the UE;
capture a user interaction with an application on the UE using the user interaction overlay, wherein the application is configured to provide an application data service to the UE via the wireless network responsive to the captured user interaction; and
forward user activity data for the captured user interaction to a centralized application node in the wireless network to trigger user-specific network analytics for the application data service, said user activity data comprising a UE identifier, information regarding the captured user interaction, and at least one identifier for the corresponding application data service.

47. The UE of claim 46, wherein to establish the user interaction overlay, the UE is configured to establish a single user interaction overlay for the UE.

48. The UE of claim 46, wherein:
to establish the user interaction overlay, the UE is configured to establish a plurality of user interaction overlay segments for the UE; and
to capture the user interaction, the UE is configured to capture, using one or more of the plurality of user interaction overlay segments, the user interaction with the application on the UE.

49. The UE of claim 48, wherein to establish the plurality of user interaction overlay segments, the UE is configured to establish the plurality of user interaction overlay segments according to a uniform grid.

50. The UE of claim 48, wherein the UE is further configured to determine a portion of a display of the UE involved in the user interaction responsive to a location of the one or more of the plurality of user interaction overlay segments used to capture the user interaction.

51. The UE of claim 46, wherein the user interaction overlay passes the captured user interaction to the application on the UE.

52. The UE of claim 46, wherein the user interaction overlay processes the captured user interaction for the application.

53. The UE of claim 46, wherein the UE is further configured to:
identify the captured user interaction as either requiring a network response or as not requiring a network response;
wherein to forward the user activity data, the UE is configured to only forward the user activity data to the centralized application node when the captured user interaction is identified as requiring a network response.

54. The UE of claim 46, wherein the user interaction comprises:
a voice command received by the UE; and/or
a user interaction with a display of the UE; and/or
a user interaction with a control button of the UE; and/or
a movement of the UE.

55. A non-transitory computer readable medium storing a computer program product for controlling a user equipment (UE) in a wireless network, the computer program product comprising software instructions that, when run on processing circuitry of the UE, cause the UE to:
establish a user interaction overlay for the UE;
capture a user interaction with an application on the UE using the user interaction overlay, wherein the application is configured to provide an application data service to the UE via the wireless network responsive to the captured user interaction; and
forward user activity data for the captured user interaction to a centralized application node in the wireless network to trigger user-specific network analytics for the application data service, said user activity data comprising a UE identifier, information regarding the captured user interaction, and at least one identifier for the corresponding application data service.
